(19) United States
(12) Patent Application Publication
(10) Pub. No.: US 2012/0143905 A1
(43) Pub. Date: Jun. 7, 2012

(54) DATA TRANSMISSION AND RECEIVING SYSTEM USING A MOBILE COMMUNICATION NETWORK AND A USER INTERFACE FOR MOBILE COMMUNICATION TERMINALS

(75) Inventor: Hyun-Ku Lee, Seoul (KR)

(73) Assignee: UBILAB INC CO., LTD., Seoul (KR)

(21) Appl. No.: 13/265,878

(22) PCT Filed: May 6, 2009
(86) PCT No.: PCT/KR2009/002380

§ 371 Date: Oct. 23, 2011

(30) Foreign Application Priority Data
May 9, 2008 (KR) 10-2008-0043339

(51) Int. Cl. G06F 17/30; G06F 15/16

(52) U.S. Cl. 707/769; 709/217; 707/E17.014

(57) ABSTRACT

A data transmission and receiving system in a mobile communication system is provided. The system includes a first data providing server which contains detailed data and to which a user gets an access by inputting a predetermined code or number through a mobile communication terminal; a second data providing server which contains a simplified data including the predetermined code or number information associated with the detailed data; and a mobile communication terminal including a user interface that allows a user access to the second data providing server to search the simplified data to access the detailed data in the first data providing server, wherein the user interface includes a search section allowing a user to input certain keyword data to search simplified data associated with the keyword data from the second data providing server and a data display section for displaying the simplified data searched by the searching section.

### TECHNICAL FIELD

The present invention relates to a multimedia data transmission and reception system using a mobile communication network. In particular, the present invention relates to a system for transmitting and receiving multimedia data, for example, in a 3G mobile video telephony communication system for providing a video telephony service over the wireless Internet, and a user interface for a mobile communication terminal.

### BACKGROUND ART

Currently, the continuous evolution of mobile communication technology has given rise to a video telephony service being provided using mobile communication systems. Additionally, a mobile communication system is providing not only a video telephony service but also a higher-speed wireless Internet service using a mobile communication system. As the wireless Internet is being opened up by mobile communication service providers, it is expected that the use of the wireless Internet over mobile communication networks will become as easy as the use of the current wired Internet and that the number of wireless Internet users will increase. A variety of types of multimedia provision technology have been developed on the assumption that the use of the wireless Internet using a mobile communication network will be activated. A major part of the use of the mobile communication network-based wireless Internet is related to accessing websites using mobile communication terminals. However, since it is inconvenient to directly input the URL addresses of websites into mobile communication terminals, technologies for accessing websites using telephone numbers or special numbers which are associated with the URL addresses of websites have been proposed.

Korean Patent No. 10-0459040 (Nov. 19, 2004) and Korean Unexamined Patent Application Publication No. 10-2005-0017803 (Feb. 23, 2005) disclose a method of searching for or accessing a URL address associated with a set number by inputting the set number into a mobile communication terminal.

Meanwhile, inventions were disclosed that are capable of combining voice with data and simultaneously transmitting the combination via the voice channel of mobile communication in a mobile communication system without using the wireless Internet.

One of the data transmission technologies using a voice channel is disclosed in Korean Patent No. 10-0436476 (Jun. 8, 2004), and is an invention that is configured to connect a PC with a transmitting mobile communication terminal, combine data, sent by the PC, with voice, and send them to a receiving mobile communication terminal via a voice channel, thus resulting in receiving data using a PC which is connected to the receiving mobile communication terminal.

Furthermore, Korean Patent No. 10-0680004 (Feb. 1, 2007) discloses an invention which is configured to combine voice with data and send and receive them between a transmitting mobile communication terminal and a receiving mobile communication terminal.

However, since access to wireless Internet websites using telephone numbers or special numbers is performed in such a way that mobile communication terminals access external websites using a device that serves to interconnect a mobile communication network with the Internet, there is the burden of having to use the interconnecting device.

The method of simultaneously transmitting voice and data using a voice channel overcomes the above-described problem of the interconnecting device. However, this method brings about the problem of the limited development of the application services therefor because the method is related to services which are provided during communications between senders and receivers in a mobile communication system.

A peer-to-peer data service, for example, in a 3G mobile communication system capable of a multimedia data service, which is provided without the intervention of the wireless Internet, must be anticipated. Here, moreover, there is a need for a system which enables transmitting mobile communication terminals to receive a variety of multimedia data services using data communication over a mobile communication network.

### DISCLOSURE

### Technical Problem

Accordingly, the present invention has been made keeping in mind the above problems occurring in the prior art, and an object of the present invention is to provide a data transmission and reception system using a mobile communication terminal, which enables the mobile communication terminal to receive a variety of multimedia data services via data communication, and a user interface for the mobile communication terminal.

Another object of the present invention is to provide a data transmission and reception system using a mobile communication terminal, in which a user interface program that enables easy access and the reception of a variety of multimedia data services even when a user does not know the telephone numbers of service providers has been installed, and a user interface for the mobile communication terminal.

### Technical Solution

In order to accomplish one object of the present invention, in accordance with a first aspect of the present invention, there are presented a data transmission and reception system, including at least one data provision server configured to have data, to access a mobile communication network, and to have a predetermined code or number; an administration server configured to assign the predetermined code or number to the data provision server, to have information about the predetermined code or number and the data provision server which matches the predetermined code or number, and to access the data provision server via a communication system; and a mobile communication terminal configured to access the mobile communication network, and to receive a data service and a voice service; wherein when the predetermined code or number is sent by inputting the predetermined code or number into the mobile communication terminal, the administration server accesses the data provision server corresponding to the received predetermined code or number, thereby enabling transmission and reception of data between the mobile communication terminal and the data provision server, and a user interface for the mobile communication terminal.

In accordance with a second aspect of the present invention, there are presented a data transmission and reception system, including a data provision server configured to include at least one data provision unit configured to have data and to have a predetermined code or number, and configured to access a mobile communication network; an administration server configured to assign the predetermined code or number to the data provision unit of the data provision server, to have information about the predetermined code or number and the data provision server which matches the predetermined code or number, and to access the data provision server via a communication system; and a mobile communication terminal configured to access the mobile communication network, and to receive a data service and a voice service; wherein when the predetermined code or number is sent by inputting the predetermined code or number into the mobile communication terminal, the administration server accesses the data provision server and then access the data provision unit corresponding to the received predetermined code or number, thereby enabling transmission and reception of data between the mobile communication terminal and the data provision unit, and a user interface for the mobile communication terminal.

In accordance with a third aspect of the present invention, there are presented a data transmission and reception system, including at least one data provision server configured to have data, to access a mobile communication network, and to have a predetermined code or number; an administration server configured to assign the predetermined code or number to the data provision server, to have information about the predetermined code or number and a registered telephone number which matches the predetermined code or number, and to access the data provision server via a communication system; and a mobile communication terminal configured to access the mobile communication network, and to receive a data service and a voice service; wherein when the registered telephone number is sent by inputting the registered telephone number into the mobile communication terminal, the administration server accesses the data provision server corresponding to the received predetermined code or number which matches the registered telephone number, thereby enabling transmission and reception of data between the mobile communication terminal and the data provision server, and a user interface for the mobile communication terminal.

In accordance with a fourth aspect of the present invention, there are presented a data transmission and reception system, including a data provision server configured to include at least one data provision unit configured to have data and to have a predetermined code or number, and configured to access a mobile communication network; an administration server configured to assign the predetermined code or number to the data provision unit of the data provision server, to have information about the predetermined code or number, the data provision server which matches the predetermined code or number, and registered telephone number which matches the predetermined code or number, and to access the data provision server via a communication system; and a mobile communication terminal configured to access the mobile communication network, and to receive a data service and a voice service; wherein when the mobile communication terminal sends the registered telephone number to the administration server, the administration server accesses the data provision server and then access the data provision unit corresponding to the received predetermined code or number which matches the registered telephone number, thereby enabling transmission and reception of data between the mobile communication terminal and the data provision unit, and a user interface for the mobile communication terminal.

Furthermore, in order to accomplish another object of the present invention, in accordance with a first aspect of the present invention, there are presented a data transmission and reception system, including at least one first data provision server configured to have detailed data and to be accessed using a mobile communication terminal and a predetermined code or number; a second data provision server configured to have at least one piece of simplified data which is related to the detailed data and includes information about the predetermined code or number; and at least one mobile communication terminal configured such that a user interface program which accesses the second data provision server, searches the simplified data and then accesses the detailed data of the first data provision server has been installed thereon; wherein the user interface program comprises a searching unit for searching for specific keyword data-related simplified data in the second data provision server by allowing the specific keyword data to be input, and a data display unit for displaying the simplified data retrieved using the searching unit, and a user interface for the mobile communication terminal.

In accordance with a second aspect of the present invention, there are presented a data transmission and reception system, including a first data provision server comprising at least one data provision unit configured to have detailed data and to be accessed using a mobile communication terminal and a predetermined code or number; a second data provision server configured to have at least one piece of simplified data which is related to the detailed data and includes information about the predetermined code or number; and at least one mobile communication terminal configured such that a user interface program which accesses the second data provision server, searches the simplified data and then accesses the detailed data of the data provision unit of the first data provision server has been installed thereon; wherein the user interface program comprises a searching unit for searching for specific keyword data-related simplified data in the second data provision server by allowing the specific keyword data to be input, and a data display unit for displaying the simplified data retrieved using the searching unit, and a user interface for the mobile communication terminal.

In accordance with a third aspect of the present invention, there are presented a data transmission and reception system, including a data provision server comprising at least one first data provision server configured to have detailed data and to be accessed using a mobile communication terminal and a predetermined code or number, and a second data provision server configured to have at least one piece of simplified data which is related to the detailed data and includes information about the predetermined code or number; and at least one mobile communication terminal configured such that a user interface program which accesses the second data provision server of the data provision server, searches the simplified data and then accesses the detailed data of the first data provision server has been installed thereon; wherein the user interface program comprises a searching unit for searching for specific keyword data-related simplified data in the second data provision server by allowing the specific keyword data to be input, and a data display unit for displaying the simplified data retrieved using the searching unit, and a user interface for the mobile communication terminal.

In accordance with a fourth aspect of the present invention, there are presented a data transmission and reception system, including at least one first data provision server configured to have detailed data and a predetermined code or number; an administration server configured to access the at least one first data provision server over a communication system, to assign the predetermined code or number to the at least one first data provision server, and to have information about the predetermined code or number and the at least one first data provision server which matches the predetermined code or number; a second data provision server configured to include a database including at least one piece of simplified data which is related to the detailed data and includes the predetermined code or number, to access the first data provision server via the communication system, and to access a mobile communication network; and a mobile communication terminal configured such that a user interface program, including a searching unit for accessing the second data provision server over the mobile communication network or a wireless Internet and searching the simplified data in the second data provision server, and a data display unit for displaying simplified data, sent by the second data provision server, in compliance with set rules or displaying simplified data retrieved from the searching unit by a user, has been installed thereon; wherein when a signal indicative of a selection related to the simplified data displayed on the data display unit of the user interface program of the mobile communication terminal occurs, the predetermined code or number included in the simplified data is sent to the administration server, and the administration server searches for the first data provision server which matches the received predetermined code or number, thereby enabling transmission and reception of data between the mobile communication terminal and the first data provision server, and a user interface for the mobile communication terminal.

In accordance with a fifth aspect of the present invention, there are presented a data transmission and reception system, including a first data provision server including at least one data provision unit configured to have detailed data and a predetermined code or number; an administration server configured to access the at least one data provision unit of the first data provision server over a communication system, to assign the predetermined code or number to the at least one data provision unit, and to have information about the predetermined code or number and the at least one data provision unit which matches the predetermined code or number; a second data provision server configured to include a database including at least one piece of simplified data which is related to the detailed data and includes the predetermined code or number, to access the first data provision server via the communication system, and to access a mobile communication network; and a mobile communication terminal configured such that a user interface program, including a searching unit for accessing the second data provision server over the mobile communication network or a wireless Internet and searching the simplified data in the second data provision server, and a data display unit for displaying simplified data, sent by the second data provision server, in compliance with set rules or displaying simplified data retrieved from the searching unit by a user, has been installed thereon; wherein when a signal indicative of a selection related to the simplified data displayed on the data display unit of the user interface program of the mobile communication terminal occurs, the predetermined code or number included in the simplified data is sent to the administration server, and the administration server searches for the data provision unit of the first data provision server which matches the received predetermined code or number, thereby enabling transmission and reception of data between the mobile communication terminal and the data provision unit, and a user interface for the mobile communication terminal.

In accordance with a sixth aspect of the present invention, there are presented a data transmission and reception system, including a data provision server comprising at least one first data provision unit configured to have detailed data and a predetermined code or number, and a second data provision unit configured to include at least one piece of simplified data which is related to the detailed data and includes the predetermined code or number; and an administration server configured to access the data provision server over a communication system, to assign the predetermined code or number to the at least one first data provision unit, and to have information about the predetermined code or number and the at least one first data provision unit which matches the predetermined code or number; a mobile communication terminal configured such that a user interface program, including a searching unit for accessing the second data provision server over the mobile communication network or a wireless Internet and searching the simplified data in the second data provision unit of the data provision server, and a data display unit for displaying simplified data, sent by the data provision server, in compliance with set rules or displaying simplified data retrieved from the searching unit by a user, has been installed thereon; wherein when a signal indicative of a selection related to the simplified data displayed on the data display unit of the user interface program of the mobile communication terminal occurs, the predetermined code or number included in the simplified data is sent to the administration server, and the administration server searches for the first data provision unit of the data provision server which matches the received predetermined code or number, thereby enabling transmission and reception of data between the mobile communication terminal and the first data provision unit, and a user interface for the mobile communication terminal.

### Advantageous Effects

The present invention has the advantage of receiving a variety of multimedia data services using calls, which are made using telephone numbers at a mobile communication terminal, in a video telephony mobile communication system capable of a video telephony service, and also has the advantage of easily accessing target multimedia data using the user interface of a mobile communication terminal even when a user does not know the telephone number of a multimedia data provider.

### DESCRIPTION OF DRAWINGS

FIG. 1 is a diagram showing the configuration of a first embodiment of a data transmission and reception system using a mobile communication network according to the present invention;

FIG. 2 is a diagram showing the configuration of a second embodiment of the data transmission and reception system using a mobile communication network according to the present invention;

FIG. 3 is a diagram showing the configuration of a third embodiment of the data transmission and reception system using a mobile communication network according to the present invention;

FIG. 4 is a diagram showing the configuration of an embodiment of the user interface of the data transmission and reception system using a mobile communication network according to the present invention;

FIG. 5 is a flowchart illustrating the process of the user interface accessing a data provision server in the data transmission and reception system using a mobile communication network according to the present invention;

FIG. 6 is a flowchart illustrating the operation of the first embodiment of the data transmission and reception system using a mobile communication network according to the present invention;

FIG. 7 is a flowchart illustrating the operation of the second embodiment of the data transmission and reception system using a mobile communication network according to the present invention; and

FIG. 8 is a flowchart illustrating the operation of the third embodiment of the data transmission and reception system using a mobile communication network according to the present invention.

### MODE FOR INVENTION

The configurations and operations of inventions regarding embodiments of the present invention will be described in detail below with reference to the accompanying drawings.

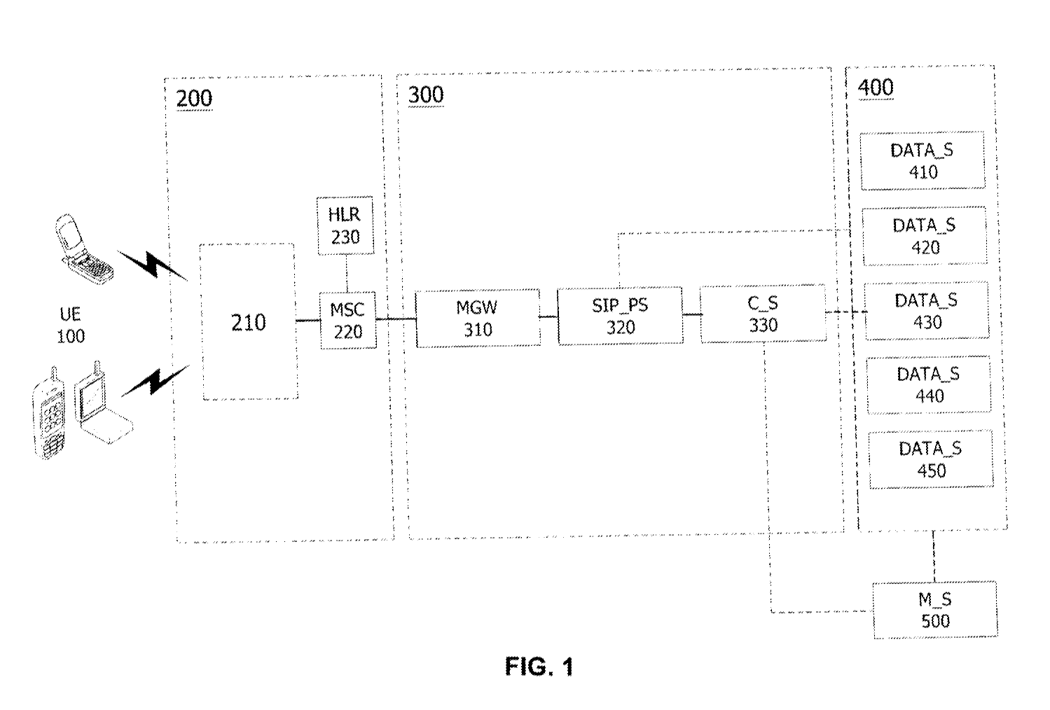

FIG. 1 is a schematic diagram showing the configuration of a data transmission and reception system using a mobile communication network according to a preferred embodiment of the present invention.

As shown in FIG. 1, the system for the first embodiment of the present invention includes mobile communication terminals 100; a mobile communication network 200 configured to include a Mobile Switching Center (MSC) 220 connected over a mobile communication network 210, and a Home Location Register (HLR) 230 configured to manage information about the location of the mobile communication terminal 100; a video telephony platform 300 configured to include a multimedia gateway 310 connected to the MSC 220 of the mobile communication network 200, a call control module server 320 connected to the multimedia gateway 310, and an administration server 330 connected to the call control module server 320; a plurality of first data provision servers 410˜450 connected to the video telephony platform 300, configured to communicate with the video telephony platform 300, and configured to have a predetermined number (or a predetermined code) so as to provide multimedia data to the mobile communication terminals 100; and a second data provision server 500 connected to the administration server 330 and the first data provision servers 410˜450.

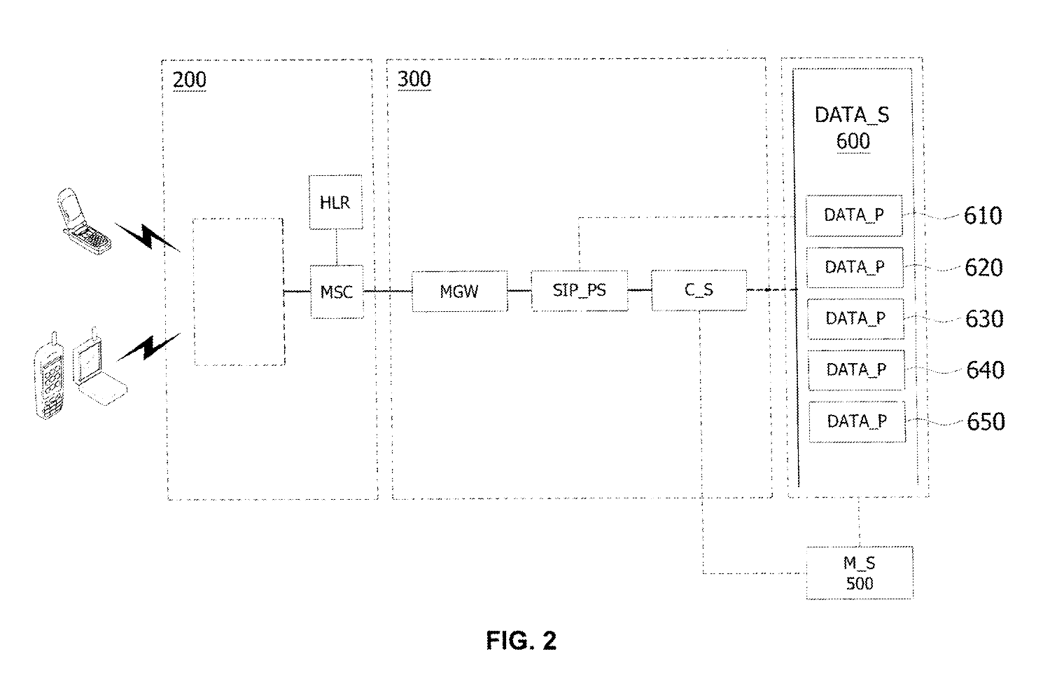

FIG. 2 is a schematic system diagram illustrating a second embodiment of the present invention.

As shown in FIG. 2, the system for the second embodiment of the present invention includes mobile communication terminals 100; a mobile communication network 200 configured to include an MSC 220 connected over a mobile communication network 210, and an HLR 230 configured to manage information about the location of the mobile communication terminal 100; a video telephony platform 300 configured to include a multimedia gateway 310 connected to the MSC 220 of the mobile communication network 200, a call control module server 320 connected to the multimedia gateway 310, and an administration server 330 connected to the call control module server 320; a first data provision servers 400 configured to include a plurality of data provision units 610˜650 connected to the video telephony platform 300, configured to communicate with the video telephony platform 300, and configured to have predetermined numbers (predetermined codes) so as to provide multimedia data to the mobile communication terminals 100; and a second data provision server 500 connected to the administration server 330 and the first data provision servers 400.

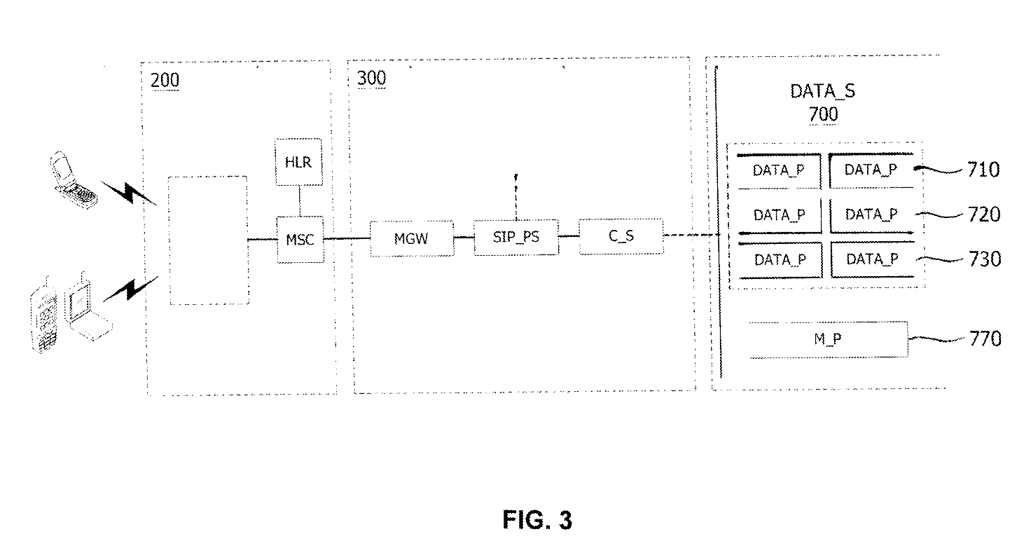

FIG. 3 is a schematic system diagram illustrating a third embodiment of the present invention.

As shown in FIG. 3, the system for the third embodiment of the present invention includes mobile communication terminals 100; a mobile communication network 200 configured to include an MSC 220 connected over a mobile communication network 210, and an HLR 230 configured to manage information about the location of the mobile communication terminal 100; a video telephony platform 300 configured to include a multimedia gateway 310 connected to the MSC 220 of the mobile communication network 200, a call control module server 320 connected to the multimedia gateway 310, and an administration server 330 connected to the call control module server 320; and a first data provision servers 400 configured to include first data provision units 710˜730 connected to the video telephony platform 300, configured to communicate with the video telephony platform 300, and configured to have predetermined numbers (or predetermined codes) so as to provide multimedia data to the mobile communication terminals 100, and a second data provision unit 700 connected to the administration server 330 and the first data provision units 710˜730.

The above-described mobile communication network 210 of the present invention includes, for example, a Radio Transceiver Subsystem (RTS; not shown) and a Radio Network Controller (RNC; not shown) which conform to the wireless access standard of the 3GPP standards. In general, the RTS functions to perform wireless access termination between a transmitting mobile communication terminal 100 and a receiving mobile communication terminal, and functions to send and receive video data including audio and image using a WCDMA method. In general, the RTS includes a Base-Station Interconnection Subsystem (BIS; not shown), a Base Band Subsystem (BBS; not shown), and a Radio Frequency Subsystem (RFS; not shown). The RNC performs functions, including the management of wired and wireless channels, protocol interfacing between the transmitting mobile communication terminal 100 and the receiving mobile communication terminal, the processing of soft handoff, protocol interfacing with a core network, fault management, and system loading, and performs the transfer of call signals and data between the RTS and the MSC 220. The MSC 220 functions to perform a call processing function in response to a call request, and includes subsystems, including an ASS (Access Switching Subsystem) for performing a distributed call processing function, an Interconnection Network Subsystem (INS) for performing the function of centralized call processing, and a Central Control Subsystem (CCS) for performing the function of centralizing administration and preservation, and a Location Registration Subsystem (LRS) for performing the function of storing and managing information about mobile subscribers.

Furthermore, the administration server 330 connected to the above-described call control module server 320 of the present invention may be implemented in, for example, a 3G-IP artificial intelligence network, which is used to provide additional service in the mobile communication system.

The plurality of first data provision servers 410˜450, the second data provision server 500, the plurality of data provision units 610˜650, the second data provision server 500, and the data provision server 700 may be internally or externally connected to the mobile communication network via a variety of types of communication means, such as the Internet. Preferably, the second data provision server 500 and the second data provision unit 770 of the data provision server 700 are connected to the mobile communication terminals 100 over the wireless Internet, and the first data provision servers 410˜450, the data provision units 610˜650 and the first data provision units 710˜730 of the data provision server 700 are connected to the mobile communication terminals 100 over a mobile communication network or the wireless Internet. However, the connection methods are not limited thereto. That is, the second data provision server 500 and the second data provision unit 770 of the data provision server 700 may also be connected to the mobile communication terminals 100 over a mobile communication network.

The first data provision servers 410˜450, the data provision units 610˜650, the first data provision units 710˜730 of the data provision server 700, the second data provision server 500, and the second data provision unit 770 of the data provision server 700 are connected to the mobile communication terminal 100 over the wireless Internet based on mobile communication, the mobile communication terminals 100 may be connected to a Serving GPRS Support Node (SGSN) via the RNC over an EP network (not shown), the SGSN may be connected to a Gateway GPRS Support Node (GGSN) over an IP-based GPRS backbone network, and the GGSN may be connected to the first data provision servers 410˜450, the data provision units 610˜650, the first data provision units 710˜730 of the data provision server 700, the second data provision server 500, and the second data provision unit 770 of the data provision server 700 over the wired/wireless Internet.

In the first to third embodiments, the first data provision servers 410˜450, data provision units 610˜650 and the first data provision units 710˜730 have a predetermined code or number information that is used to make access via the communication system. Furthermore, they also have multimedia data (detailed data) which will be provided to the mobile communication terminal 100.

The second data provision server 500 and the second data provision unit 770 may include simplified data about the detailed data, for example, the predetermined code or number information assigned to the first data provision servers 410˜450, the data provision units 610˜650 and the first data provision units 710˜730 and a brief description related to the multimedia data.

Furthermore, the second data provision server 500 and the second data provision unit 770 may have a different category of simplified data for each type of predetermined numbers. For example, when the type of predetermined number is “100-XXXX,” simplified data which matches the predetermined number may be stored with the category of the corresponding detailed data being information about local restaurants.

Furthermore, the simplified data may be stored in association with information about fixed locations. A serviceable period may be set for the detailed data, and the serviceable period may be stored in association with the simplified data.

The administrators of the first data provision servers 410˜450, the data provision units 610˜650 and the first data provision units 710˜730 which have the detailed data may register the simplified data that the second data provision server 500 and the second data provision unit 770 have. Accordingly, it is not necessary for the number of pieces of simplified data to be equal to the number of pieces of detailed data.

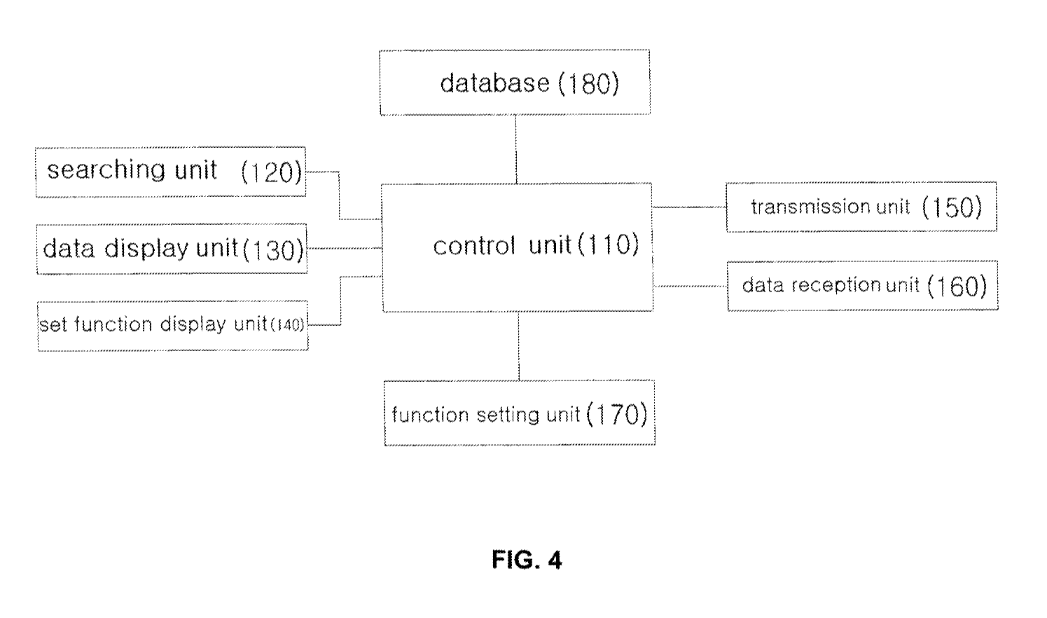

FIG. 4 is a diagram illustrating the configuration of an embodiment of a user interface program which was installed in the mobile communication terminals 100 of the first to third embodiments of the present invention, or which is installed by downloading it to the mobile communication terminals 100. The user interface program of the present invention is installed in the mobile communication terminal 100 and stored in memory so as to ensure the reliability and rapidity thereof.

As shown in FIG. 4, the user interface of the present invention includes a searching unit 120 for, when the user interface has been installed in a mobile communication terminal 100, being displayed on the screen of the mobile communication terminal 100, receiving a search keyword, making a search request, and then retrieving at least one piece of simplified data from the second data provision server 500 or second data provision unit 770, a data display unit 130 for displaying at least one piece of simplified data which is returned from the searching performed by the searching unit 120 or at least one piece of simplified data which is sent by the second data provision server 500 or second data provision unit 770 in compliance with preset rules, a function setting unit 170 for setting various functions which can be implemented in the user interface, a set function display unit 140 for displaying the functions, set by the function setting unit 170, using, for example, buttons on the screen of the mobile communication terminal 100, a database 180 for storing specific keywords and the predetermined numbers or predetermined codes adapted to match the specific keywords and assigned to the first data provision servers 410˜450, the data provision units 610˜650 and the first data provision units 710˜730, or specific telephone numbers registered in the administration server 330 and adapted to match the predetermined numbers, a transmission unit 150 for, when a search keyword input via the user interface, a specific keyword, a predetermined number or a specific telephone number is input and there is a transmission signal, transmitting the input data to the MSC 220, a data reception unit 160 for receiving data from the second data provision server 500, the second data provision unit 770, the first data provision servers 410˜450, the data provision units 610˜650 and the first data provision units 710˜730, and a control unit 110 for controlling the operation of the above-described components.

Any one of the second data provision server 500, the second data provision unit 770 and the administration server 330 may include the database 180 of the user interface. A specific keyword stored in the database 180 in association with the predetermined number may be, for example, the number of a person or a company who or which provides the multimedia data, and a specific telephone number may be, for example, an existing telephone number.

Furthermore, the transmission unit 150 and the data reception unit 160 may be implemented using computer program modules which are related to the communication unit of the mobile communication terminal 100.

The user interface may receive a search keyword via the searching unit 120, and the second data provision server 500 or second data provision unit 770 searches for simplified data related to the keyword. Accordingly, it is preferred that the second data provision server 500 or second data provision unit 770 store keyword data associated with the simplified data. Furthermore, by inputting a specific keyword into the searching unit 120, the first data provision servers 410˜450, the data provision units 610˜650 and the first data provision units 710˜730 may be accessed using a predetermined number or code which matches the input specific keyword in the database 180. Furthermore, by inputting a specific telephone number into the searching unit 120, the first data provision servers 410˜450, the data provision units 610˜650 and the first data provision units 710˜730 may be accessed using the predetermined number or code which matches the input specific keyword in the database 180. Furthermore, by inputting a predetermined number into the mobile communication terminal 100, the first data provision servers 410˜450, the data provision units 610˜650 and the first data provision units 710˜730 may be accessed.

Furthermore, by inputting a specific telephone number into the mobile communication terminal 100, the first data provision servers 410˜450, the data provision units 610˜650 and the first data provision units 710˜730 may be accessed using a predetermined number or code which matches the input specific telephone number in the database 180.

The function setting unit 170 of the user interface may, for example, register a desired Internet URL address which is desired to be used over the wireless Internet, set call initiation and termination buttons which enable a user to make a call while receiving multimedia data, or set a storage button which is used to store the predetermined number of the multimedia data which is being provided. The function buttons set by the function setting unit 170 may be displayed on the set function display unit 140 which is provided on a specific area of the user interface screen.

Furthermore, the user interface may include search condition setting means provided in the searching unit 120, and may further include location information input means configured to input desired location information so as to search for simplified data which has specific location information.

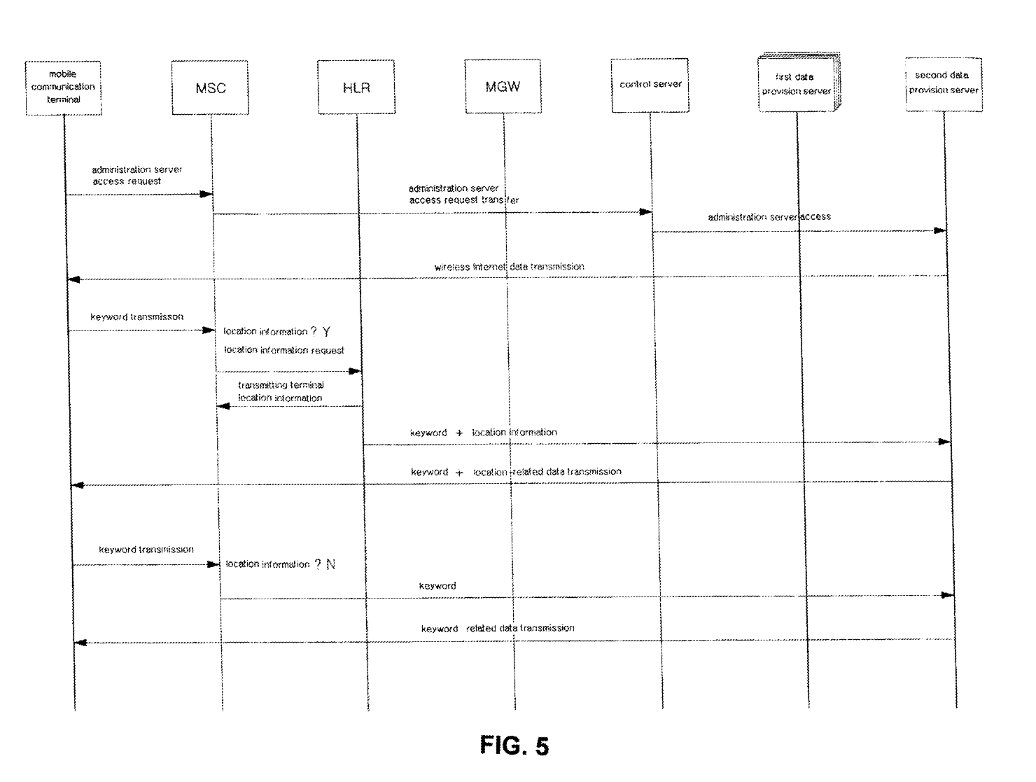

FIGS. 5 to 8 are flowcharts illustrating the operation of the above-described embodiments of FIGS. 1 to 3.

In the present invention, for example, the technical particulars of accessing the wireless Internet based on mobile communication using a mobile communication terminal and the technical particulars of transmitting multimedia packet data to a mobile communication terminal over a mobile communication network are well known, so that detailed descriptions thereof will be omitted.

FIG. 5 illustrates the process of, to receive a multimedia data service using a mobile communication terminal 100 of the present invention, accessing the second data provision server 500 or second data provision unit 770 using the user interface and searching for at least one of the first data provision servers 410˜450, the data provision units 610˜650 and the first data provision units 710˜730 which provide multimedia data.

To access the second data provision server 500 or second data provision unit 770, the mobile communication terminal 100 sends an input signal, executing the user interface, to the MSC 220 over a mobile communication wireless network 210. The MSC 220 which has received a signal requesting access to the second data provision server 500 or second data provision unit 770 performs control so that the mobile communication terminal 100 can access the second data provision server 500 or second data provision unit 770 by transmitting data, requesting access to the second data provision server 500 or second data provision unit 770, to the administration server 330. The second data provision server 500 or second data provision unit 770 accessed by the mobile communication terminal 100 may send, for example, at least one piece of preset simplified data, and cause the data to be displayed on the data display unit 130 of the user interface of the mobile communication terminal 100. The access of the mobile communication terminal 100 to the second data provision server 500 or second data provision unit 770 may be achieved using the wireless Internet or a mobile communication network.

The mobile communication terminal 100 which has accessed the second data provision server 500 or second data provision unit 770 makes a search request by inputting a specific search keyword into the searching unit 120 of the user interface, thereby transmitting the search keyword to the MSC 220. The MSC 220 receives the search request, and determines whether location information has been included in the search request data. If location information is included in the search request data, the MSC 220 requests information about the location of the mobile communication terminal 100 from the HLR, or sends the search keyword and information about the location of the mobile communication terminal 100 to the second data provision server 500 or second data provision unit 770 based on location information that the mobile communication terminal 100 itself has. The second data provision server 500 or second data provision unit 770 searches for at least one piece of simplified data which matches both the keyword and the location information based on the received search keyword and location information and then sends retrieved simplified data to the mobile communication terminal 100, thereby displaying it on the data display unit 130 of the user interface.

Here, the simplified data that the second data provision server 500 or second data provision unit 770 has includes information about fixed locations. When the user interface of the mobile communication terminal 100 makes a request for a search of simplified data, the simplified data having location information which is found, for example, using the location information that the mobile communication terminal 100 itself has or using the results of a search for the current location of the mobile communication terminal 100 in the HLR, may be displayed on the data display unit 130 of the user interface.

Alternatively, the user interface of the mobile communication terminal 100 may further include location information input means, and the simplified data that the second data provision server 500 or second data provision unit 770 may have information about fixed locations. When a location is input to the user interface of the mobile communication terminal 100 using the location information input means and a request for a search for simplified data is made, simplified data having location information corresponding to the location information input using the location information input means may be displayed on the data display unit 130 of the user interface.

Furthermore, when the search keyword received from the MSC 220 does not include location information, the received keyword is sent to the second data provision server 500 or second data provision unit 770, and the second data provision server 500 or second data provision unit 770 searches for at least one piece of simplified data which matches the received search keyword, and sends the simplified data to the mobile communication terminal 100, thereby displaying it on the data display unit 130 of the user interface.

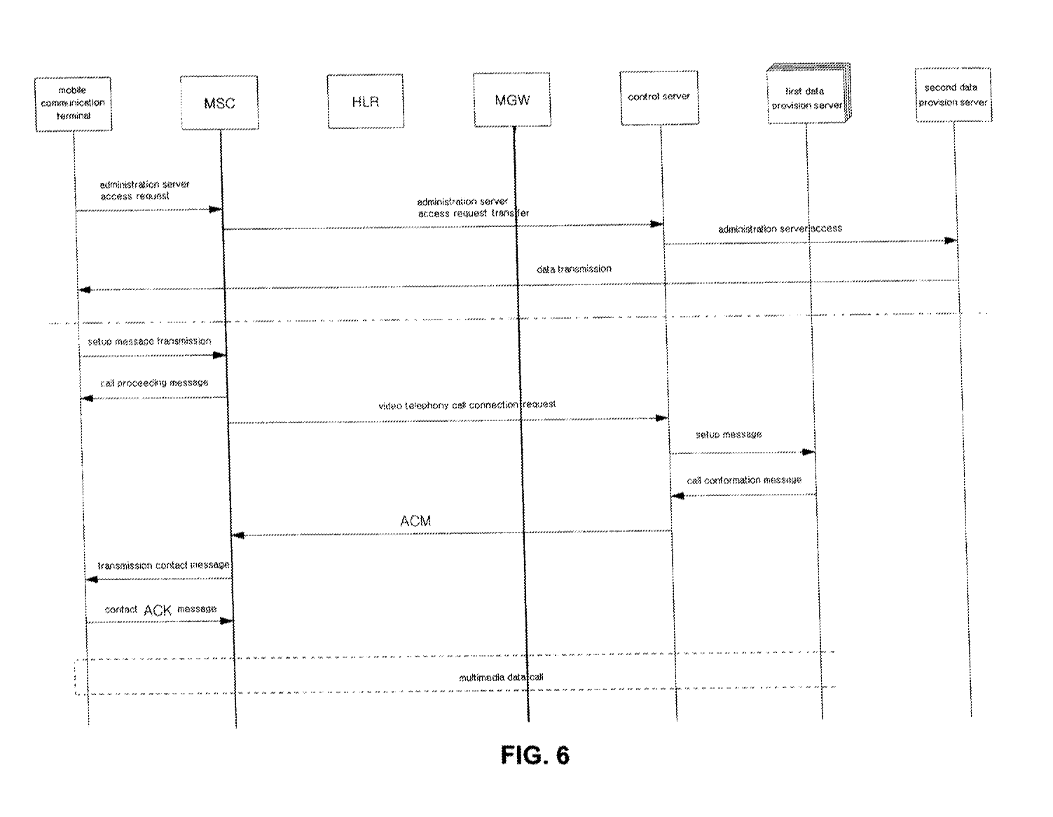

FIG. 6 is a flowchart illustrating the process of receiving a multimedia data service using the first embodiment of the present invention.

When, in the description of FIG. 5, a mobile communication network is used, the mobile communication terminal 100 accesses the second data provision server 500, at least one piece of simplified data is searched for and displayed on the data display unit 130 of the user interface installed in the mobile communication terminal, and then there occurs a signal selecting a specific piece of simplified data from the simplified data displayed on the data display unit 130, the control unit 110 of the user interface sends a setup message, including a predetermined number included in the selected simplified data, to the MSC 220 using the transmission unit 150. The setup message is a call connection request that requests the setup of a call path. The MSC 220 receives the setup message, determines whether the received predetermined number is a registered telephone number, sends a call proceeding message, indicating the intention to make an attempt to set up a call connection, to the mobile communication terminal 100, and sends a call connection message to the administration server 330. The administration server 330 receives the received call connection request message from the MSC 220, and sends a setup message to the one of the plurality of first data provision servers 410˜450 to which the predetermined number was assigned. The first data provision server receives the setup message, and sends a call confirmation message to the administration server 330. The administration server 330 receives the call confirmation message from the first data provision server, and sends a message ACM, indicating the setup of a call connection, to the MSC 220. The MSC 220 receives the ACM and sends a transmission contact message to the mobile communication terminal 100, and the mobile communication terminal 100 sends a contact ACK message to the MSC 220 in response to the contact message, so that a communication path is set up between the mobile communication terminal 100 and the first data provision server. Thereafter, the first data provision server sends multimedia data to the mobile communication terminal 100, so that data communication between the mobile communication terminal 100 and the first data provision server is initiated.

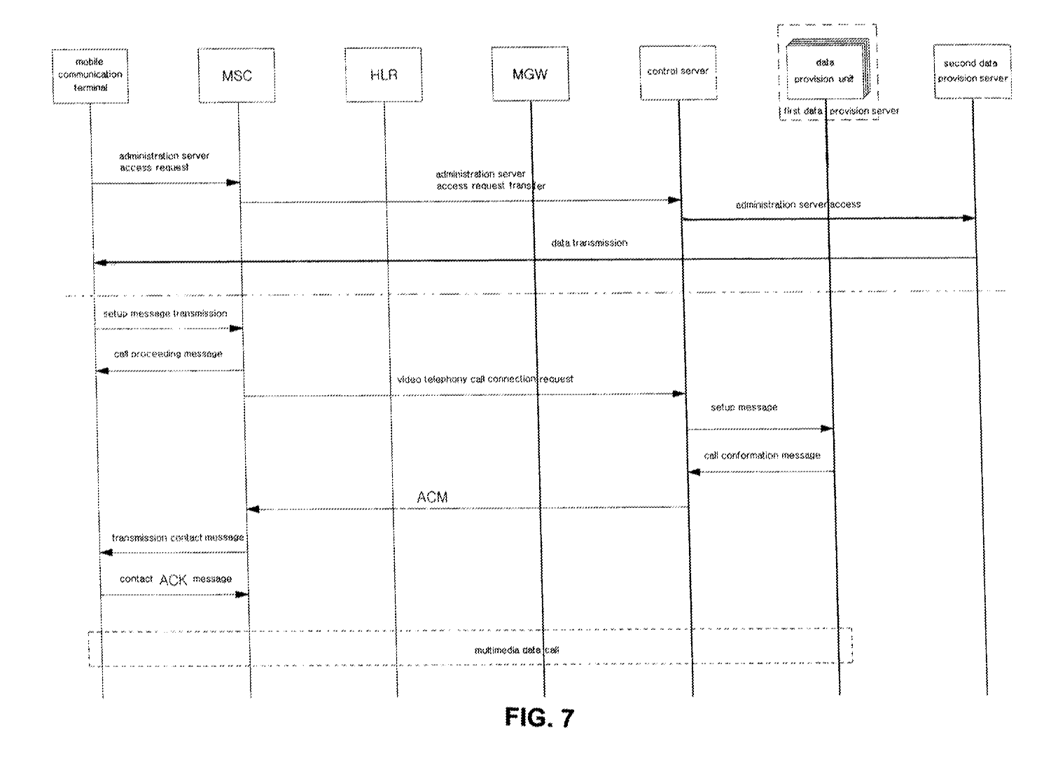

FIG. 7 is a flowchart illustrating the second embodiment of the present invention. The flowchart of FIG. 7 is almost identical to the above-described flowchart of the first embodiment of FIG. 6. The former flowchart is different from the latter only in the configuration of the data provision server which provides multimedia data. In accordance with the second embodiment of the present invention shown in FIG. 7, in the structure for providing multimedia data to mobile communication terminals 100, for example, one or more first data provision servers 600 are provided, predetermined numbers are assigned to the one or more data provision servers 600, respectively, and a plurality of data provision units 610˜650 having multimedia data (detailed data) is provided.

When, in the description of FIG. 5, the mobile communication terminal 100 accesses the second data provision server 500, at least one piece of simplified data is searched for and displayed on the data display unit 130 of the user interface, and then there occurs a signal selecting a specific piece of simplified data from the simplified data displayed on the data display unit 130, the control unit 110 of the user interface sends a setup message, including a predetermined number included in the selected simplified data, to the MSC 220 using the transmission unit 150. The setup message is a call connection request that is for requesting the setup of a call path. The MSC 220 receives the setup message, determines whether the received predetermined number is a registered telephone number, sends a call proceeding message, indicating the intention to make an attempt to set up a call connection, to the mobile communication terminal 100, and sends call connection message to the administration server 330. The administration server 330 receives the received call connection request message from the MSC 220, and sends a setup message to the one of the plurality of data provision units 410˜450 to which the predetermined number was assigned. The data provision unit receives the setup message, and sends a call confirmation message to the administration server 330. The administration server 330 receives the call confirmation message from the data provision unit, and sends a message ACM, indicating the setup of a call connection, to the MSC 220. The MSC 220 receives the ACM and sends a transmission contact message to the mobile communication terminal 100, and the mobile communication terminal 100 sends a contact ACK message to the MSC 220 in response to the contact message, so that a communication path is set up between the mobile communication terminal 100 and the data provision unit. Thereafter, the data provision unit sends multimedia data to the mobile communication terminal 100, so that data communication between the mobile communication terminal 100 and the data provision unit is initiated.

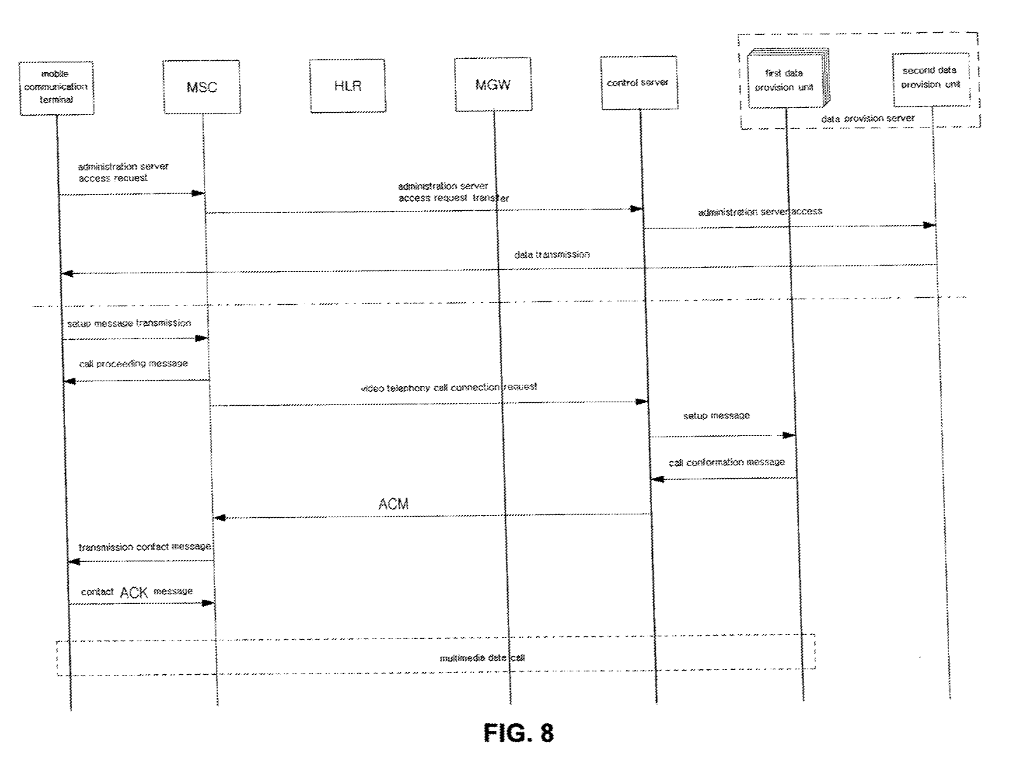

FIG. 8 is a flowchart illustrating the third embodiment of the present invention. The flowchart of FIG. 8 is almost identical to the above-described flowchart of the first embodiment of FIG. 6. The former flowchart is different from the latter only in the configuration of the first data provision server which provides multimedia data and in the configuration of the second data provision server which provides simplified data.

In accordance with the third embodiment of the present invention shown in FIG. 8, in the structure for providing multimedia data to mobile communication terminals 100, for example, a single data provision server 700, is provided, and the data provision server 700 includes a plurality of first data provision units 710˜730 having respective predetermined numbers and multimedia data (detailed data) and a second data provision unit 770 having simplified data about the multimedia data.

When, in the description of FIG. 5, the mobile communication terminal 100 accesses the second data provision server 770 of the data provision server 700, at least one piece of simplified data is searched for and displayed on the data display unit 130 of the user interface, and then there occurs a signal selecting a specific piece of simplified data from the simplified data displayed on the data display unit 130, the control unit 110 of the user interface sends a setup message, including a predetermined number included in the selected simplified data, to the MSC 220 using the transmission unit 150. The setup message is a call connection request that requests the setup of a call path. The MSC 220 receives the setup message, determines whether the received predetermined number is a set video telephony telephone number, sends a call proceeding message, indicating the intention to make an attempt to set up a video telephony call connection, to the mobile communication terminal 100, and sends a call connection message to the administration server 330. The administration server 330 receives the received call connection request message from the MSC 220, and sends a setup message to the one of the plurality of first data provision units 710˜730 which belong to the data provision server 700 and to which the predetermined number was assigned. The first data provision unit receives the setup message, and sends a call confirmation message to the administration server 330. The administration server 330 receives the call confirmation message from the first data provision unit, and sends a message ACM, indicating the setup of a video telephony call connection, to the MSC 220. The MSC 220 receives the ACM and sends a transmission contact message to the mobile communication terminal 100, and the mobile communication terminal 100 sends a contact ACK message to the MSC 220 in response to the contact message, so that a communication path is set up between the mobile communication terminal 100 and the first data provision unit. Thereafter, the first data provision unit sends multimedia data to the mobile communication terminal 100, so that data communication between the mobile communication terminal 100 and the first data provision unit is initiated.

The reason why the above-described first embodiment to third embodiments of the present invention are different from one another is that when the multimedia data is a large amount of data or corresponds to a predetermined number for which a large number of call access requests are made, it is preferable to provide independent first data provision servers 410˜450, as shown in FIG. 6. In contrast, when the multimedia data to be provided is simple data such as simple information or when a small number of access requests are made by the mobile communication terminal 100, it is preferable to provide one or more first data provision servers 600 each including the plurality of data provision units 610˜650 or it is preferable to provide the data provision server 700 including both the plurality of first data provision units 710˜730 and the second data provision unit 770 corresponding to the second data provision server 500 in the first and second embodiments.

Furthermore, in the above-described first to third embodiments of the present invention, the predetermined number which is sent from the mobile communication terminal 100 to the MSC 220 may be configured to enable the MSC 220 to recognize a dedicated video telephony number. Alternatively, means capable of recognizing a dedicated video telephony number may be provided in the administration server 330.

The multimedia data which is sent by the first data provision server 410˜440, or 450, the data provision unit 610˜640, or 650 or the first data provision unit 710, 720 or 730 to the mobile communication terminal 100 when a communication path is set up between the mobile communication terminal 100 and the first data provision server 410˜440, or 450, the data provision unit 610˜640 or 650 or the first data provision unit 710, 720 or 730 may be, for example, data which is output in such a way that when an input signal related to the multimedia data occurs in the mobile communication terminal 100, the first data provision server 410˜440, or 450, the data provision unit 610˜640, or 650 or the first data provision unit 710, 720 or 730 sends data to the mobile communication terminal 100 in response to the input signal and the data is output via the mobile communication terminal 100. Alternatively, the multimedia data may be data which is used which is sent by the first data provision server 410˜440, or 450, the data provision unit 610˜640, or 650 or the first data provision unit 710, 720 or 730 to unilaterally give a direction or provide information. However, the multimedia data is preferably interactive data that is exchanged in such a way that the mobile communication terminal 100 performs the input of a necessary signal in response to the multimedia data provided by the first data provision server 410˜440 or 450, the data provision unit 610˜640 or 650, or the first data provision unit 710, 720 or 730, and the first data provision server 410˜440 or 450, the data provision unit 610˜640 or 650 or the first data provision unit 710, 720 or 730 responds to the input of the signal using prepared data, because the embodiments of the present invention are oriented toward data communication between the mobile communication terminal 100 and the first data provision server 410˜440 or 450, the data provision unit 610˜640 or 650 or the first data provision unit 710, 720 or 730.

In the first to third embodiments of the present invention, the multimedia data (detailed data) and the simplified data may each include text, a graphic image(s), a photo image(s), a moving image(s), a sound(s), a program(s) implemented in one or more of various computer languages, such as Java, and/or a combination(s) thereof.

Furthermore, in the first to third embodiments of the present invention, the predetermined numbers assigned to the first data provision servers 410˜450, the data provision units 610˜650 and the first data provision units 710˜730 may be replaced with predetermined codes.

Furthermore, although the first to third embodiments of the present invention have been described as being configured to input a keyword, a predetermined number, a specific keyword or a specific telephone number into the searching unit 120 of the user interface, to access the first data provision server 410˜440 or 450, the data provision server 610˜610 or 650 or the first data provision unit 710, 720 or 730 and to perform data communication, the mobile communication terminal 100 may make a phone call request by directly inputting the predetermined number so that the MSC 220 or administration server 330 recognizes the predetermined number as a number which requests a data call to the first data provision server 410˜440, or 450, the data provision server 610˜630, or 650 and the first data provision unit 710, 720 or 730, thereby performing the above-described call connection procedure.

Furthermore, when the mobile communication terminal 100 is switched on for the purpose of use, the user interface may be displayed on the screen of the mobile communication terminal 100. Alternatively, when the mobile communication terminal 100 is switched on and also a signal is input using a specific button or part of the predetermined number or the entire predetermined number is input, the user interface may be displayed on the screen of the mobile communication terminal 100.

Furthermore, the user interface may be displayed on the screen of the mobile communication terminal 100 and, at the same time, may access the second data provision server 500 or the second data provision unit 770. Alternatively, when the user interface is displayed on the screen of the mobile communication terminal 100 and also a predetermined signal is input, the user interface may access the second data provision server 500 or second data provision unit 770.

Furthermore, a data provider terminal which accesses the second data provision server or the second data provision unit 770 via a communication system may be further included, and the data provider terminal may access the second data provision server or the second data provision unit 770 and then register simplified data or change the stored simplified data-related information.

### INDUSTRIAL APPLICABILITY

The present invention enables multimedia communication to be performed using a simple number or a keyword search in a mobile communication terminal.

1. A data transmission and reception system, comprising:
a first data provision server configured to have detailed data and to be accessed using a mobile communication terminal and a predetermined code or number;
a second data provision server configured to have simplified data which is related to the detailed data and includes information about the predetermined code or number; and
a mobile communication terminal configured such that a user interface program which accesses the second data provision server, searches the simplified data and then accesses the detailed data of the first data provision server has been installed thereon;
wherein the user interface program comprises a searching unit for searching for keyword data-related simplified data in the second data provision server by allowing the keyword data to be input, and a data display unit for displaying the simplified data retrieved using the searching unit.

2. A data transmission and reception system, comprising:
a data provision server comprising a first data provision unit configured to have detailed data and to be accessed using a mobile communication terminal and a predetermined code or number, and a second data provision unit configured to have simplified data which is related to the detailed data and includes information about the predetermined code or number; and
a mobile communication terminal configured such that a user interface program which accesses the second data provision unit of the data provision server, searches the simplified data and then accesses the detailed data of the first data provision unit has been installed thereon;
wherein the user interface program comprises a searching unit for searching for keyword data-related simplified data in the second data provision unit by allowing the keyword data to be input, and a data display unit for displaying the simplified data retrieved using the searching unit.

3. A data transmission and reception system, comprising:
a first data provision server configured to have detailed data and a predetermined code or number;
an administration server configured to access the first data provision server over a communication system, to assign the predetermined code or number to the first data provision server, and to have information about the predetermined code or number and the first data provision server which matches the predetermined code or number;
a second data provision server configured to include a database including simplified data which is related to the detailed data and includes the predetermined code or number, to access the first data provision server via the communication system, and to access a mobile communication network; and
a mobile communication terminal configured such that a user interface program, including a searching unit for accessing the second data provision server over the mobile communication network or a wireless Internet and searching the simplified data in the second data provision server, and a data display unit for displaying simplified data, sent by the second data provision server, in compliance with set rules or displaying simplified data retrieved from the searching unit by a user, has been installed thereon;
wherein when a signal indicative of a selection related to the simplified data displayed on the data display unit of the user interface program of the mobile communication terminal occurs, the predetermined code or number included in the simplified data is sent to the administration server, and the administration server searches for the first data provision server which matches the received predetermined code or number, thereby enabling transmission and reception of data between the mobile communication terminal and the first data provision server.

4. A data transmission and reception system, comprising:
a data provision server comprising a first data provision unit configured to have detailed data and a predetermined code or number, and a second data provision unit configured to include simplified data which is related to the detailed data and includes the predetermined code or number; and
an administration server configured to access the data provision server over a communication system, to assign the predetermined code or number to the first data provision unit, and to have information about the predetermined code or number and the first data provision unit which matches the predetermined code or number;
a mobile communication terminal configured such that a user interface program, including a searching unit for accessing the second data provision server over the mobile communication network or a wireless Internet and searching the simplified data in the second data provision unit of the data provision server, and a data display unit for displaying simplified data, sent by the data provision server, in compliance with set rules or displaying simplified data retrieved from the searching unit by a user, has been installed thereon;
wherein when a signal indicative of a selection related to the simplified data displayed on the data display unit of the user interface program of the mobile communication terminal occurs, the predetermined code or number included in the simplified data is sent to the administration server, and the administration server searches for the first data provision unit of the data provision server which matches the received predetermined code or number, thereby enabling transmission and reception of data between the mobile communication terminal and the first data provision unit.

5. The data transmission and reception system as set forth in any one of claims 1 to 4, wherein the user interface program accesses the first data provision server, the second data provision server, and the data provision server over the mobile communication network or the wireless Internet based on mobile communication.

6. The data transmission and reception system as set forth in any one of claims 1 to 4, further comprising a data provider terminal for accessing the second data provision server or the data provision server via the communication system, wherein using the data provider terminal, simplified data may be registered in the second data provision server or the second data provision unit of the data provision server or the stored simplified data-related information may be changed.

7. The data transmission and reception system as set forth in any one of claims 1 to 4, wherein the simplified data includes information about at least one fixed location, and, when the user interface program of the mobile communication terminal requests a search for simplified data, the simplified data having location information corresponding to a retrieved location is displayed on the data display unit of the user interface program based on results of a search of a current location of the mobile communication terminal.

8. The data transmission and reception system as set forth in any one of claims 1 to 4, wherein a number of the simplified data is equal to or smaller than a number of the detailed data.

9. The data transmission and reception system as set forth in any one of claims 1 to 4, wherein the predetermined code or number is sent by inputting the predetermined code or number into the searching unit of the user interface program, detailed data corresponding to the input predetermined code or number is sent to the mobile communication terminal and is displayed on the user interface program.

10. The data transmission and reception system as set forth in any one of claims 1 to 4, wherein:
the second data provision server or the second data provision unit further includes keyword data information which matches the predetermined code or number or the simplified data; and
when keyword data is sent by the user interface program of the mobile communication terminal, the second data provision server or second data provision unit sends simplified data which matches the received keyword data to the mobile communication terminal.

11. The data transmission and reception system as set forth in any one of claims 1 to 4, wherein:
the second data provision server or the second data provision unit further includes keyword data information which matches the predetermined code or number or the simplified data; and
when keyword data is sent by the user interface program of the mobile communication terminal, the second data provision server or second data provision unit sends simplified data which matches the received keyword data to the first data provision server or first data provision units, and the first data provision server or the first data provision unit sends the detailed data to the mobile communication terminal.

12. The data transmission and reception system as set forth in any one of claims 1 to 4, wherein:
the user interface program of the mobile communication terminal or the administration server further comprises a keyword database for storing the predetermined code or number and keyword data which matches the predetermined code or number; and
when the keyword data is input into the searching unit of the user interface program, the predetermined code or number which matches the input keyword data in the keyword database is sent, thereby enabling detailed data corresponding to the predetermined code or number to be output via the mobile communication terminal.

13. A data transmission and reception system, comprising:
a data provision server configured to have data, to access a mobile communication network, and to have a predetermined code or number;
an administration server configured to have information about a data provision server which matches the predetermined code or number, and to access the data provision server over a mobile communication network; and
a mobile communication terminal configured to access the mobile communication network, and to receive a data service and a voice service;
wherein when the predetermined code or number is sent by inputting the predetermined code or number into the mobile communication terminal, the administration server accesses a data provision server corresponding to the received predetermined code or number, thereby enabling transmission and reception of data between the mobile communication terminal and the data provision server.

14. A data transmission and reception system, comprising:
a data provision server configured to have data, to access a mobile communication network, and to have a predetermined code or number;
an administration server configured to have information about a registered telephone number which matches the predetermined code or number, and to access the data provision server over a mobile communication network; and
a mobile communication terminal configured to access the mobile communication network, and to receive a data service and a voice service;
wherein when the registered telephone number is sent by inputting the registered telephone number into the mobile communication terminal, the administration server accesses a data provision server corresponding to the received predetermined code or number which matches the registered telephone number, thereby enabling transmission and reception of data between the mobile communication terminal and the data provision server.

15. The data transmission and reception system as set forth in claim 13 or 14, wherein:
the mobile communication terminal comprises a telephone number database for storing data about the registered telephone number and data about the predetermined code or number which matches the registered telephone number data; and
when the registered telephone number is input to the mobile communication terminal, the telephone number database sends the predetermined code or number which matches the input telephone number.

16. The data transmission and reception system as set forth in claim 13 or 14, wherein the transmission and reception of data between the mobile communication terminal and the data provision server, the data provision unit or the first data provision unit, which are initiated by the administration server, are performed over the mobile communication network or a wireless Internet.

17. A user interface for, a mobile communication terminal, the user interface being installed in the mobile communication terminal and stored in memory, comprising:
a searching unit for allowing predetermined keyword data to be input and searching for at least one piece of simplified data related to the keyword data in a second data provision server which has at least one piece of simplified data including information about a predetermined code or number and which accesses the mobile communication terminal;
a data display unit for displaying the at least one piece of simplified data or detailed data retrieved using the searching unit;
a transmission unit for, when an input signal indicative of a selection related to the at least one piece of simplified data displayed on the data display unit occurs, transmitting the predetermined code or number, included in the simplified data related to the input signal, via a communication system; and
a data reception unit for receiving detailed data provided by a first data provision server which has the detailed data and to which the predetermined code or number sent by the transmission unit has been assigned.

18. A user interface for a mobile communication terminal, the user interface being installed in the mobile communication terminal and stored in memory, comprising:
a searching unit for allowing predetermined keyword data to be input and searching for at least one piece of simplified data related to the keyword data in a data provision server, comprising a first data provision unit configured to have detailed data and assigned a predetermined code or number, and a second data provision unit configured to have at least one piece of simplified data including information about the predetermined code or number and which accesses a mobile communication terminal;
a data display unit for displaying the at least one piece of simplified data or detailed data retrieved using the searching unit;
a transmission unit for, when an input signal indicative of a selection related to the at least one piece of simplified data displayed on the data display unit occurs, transmitting the predetermined code or number, included in the simplified data related to the input signal, via a communication system; and
a data reception unit for receiving detailed data provided by a first data provision server to which the predetermined code or number sent by the transmission unit has been assigned.

19. The user interface as set forth in claim 17 or 18, wherein the user interface further comprises a control unit for performing control so that when simplified data is searched for using the searching unit, the access to the second data provision server or the second data provision unit of the data provision server is made using a wireless Internet.

20. The user interface as set forth in claim 17 or 18, wherein the user interface further comprises a control unit for performing control so that the transmission unit and the data reception unit access the first data provision server and the first data provision unit of the data provision server over the mobile communication network or a wireless Internet.

21. The user interface as set forth in claim 17 or 18, wherein the user interface further comprises a function setting unit for setting and registering at least one function and a set function display unit for displaying the at least one function set which has been set and registered by the function setting unit.

22. The user interface as set forth in claim 17 or 18, wherein:
the at least one piece of simplified data includes information about a fixed location; and
when predetermined keyword data is input into the searching unit, a current location of the mobile communication terminal is searched for, and at least one piece of simplified data which has location information corresponding to the retrieved location and is related to the keyword data is displayed on the data display unit of the user interface.

23. The user interface as set forth in claim 17 or 18, wherein:
the at least one piece of simplified data includes information about a fixed location; and
when location information and predetermined keyword data are input into the searching unit, at least one piece of simplified data which has location information corresponding to the input location data and is related to the keyword data is displayed on the data display unit of the user interface.

24. The user interface as set forth in claim 17 or 18, further comprising a data provider terminal for accessing the second data provision server or the second data provision unit of the data provision server via the communication system,
wherein simplified data or a request for a change in information about the simplified data is registered using the data provider terminal.

25. The user interface as set forth in claim 17 or 18, wherein when the predetermined code or number is sent by inputting the predetermined code or number into the mobile communication terminal or the searching unit of the user interface, detailed data is sent by the first data provision server or the first data provision unit to which the predetermined code or number has been assigned and then displayed on the mobile communication terminal.

26. The user interface as set forth in claim 17 or 18, wherein:
the user interface further comprises a number and keyword database for storing at least one number data or at least one keyword data, and for storing the at least one predetermined code or number data which matches the number data or keyword data; and
when the number or keyword data is input into the mobile communication terminal or the searching unit of the user interface, the number and keyword database sends the predetermined code or number which matches the input number and keyword data, and the detailed data is sent by the first data provision server or the first data provision unit to which the predetermined code or number has been assigned, and is then displayed on the mobile communication terminal.

27. The user interface as set forth in claim 17 or 18, wherein the user interface further comprises a picture which is displayed on the mobile communication terminal when the mobile communication terminal is switched on to be used.

28. The user interface as set forth in claim 17 or 18, wherein the user interface further comprises a picture which is displayed on a display window of the mobile communication terminal when the mobile communication terminal is switched on to be used and also when a signal is input using a keypad of the mobile communication terminal or a predetermined button on a touch screen of the mobile communication terminal or a specific number is input.

29. The user interface as set forth in claim 17 or 18, wherein when a picture of the user interface is displayed on a display window of the mobile communication terminal and/or a predetermined screen of the user interface is displayed on a display window of the mobile communication terminal and also when a predetermined input signal occurs in the mobile communication terminal, the user interface accesses the second data provision server or the second data provision unit over the mobile communication network or a wireless Internet.
